(19) United States
(12) Patent Application Publication
(10) Pub. No.: US 2004/0052606 A1
(43) Pub. Date: Mar. 18, 2004

(54) Dowell for lightweight building materials and use of a screw driver bit for screwing in such dowels

(76) Inventor: Gregor Kerl, Abt-Knittel-Strasse (DE)

Correspondence Address: Michael J McGovern, Quarles & Brady, 411 East Wisconsin Ave, Milwaukee, WI, 53202-4497, US

(21) Appl. No.: 10/343,772

(22) PCT Filed: Jul. 18, 2001
(86) PCT No.: PCT/EP01/08269

(30) Foreign Application Priority Data
Aug. 4, 2000 (DE) 100 38 016.6

(51) Int. Cl. F16B 1/00

(52) U.S. Cl. 411/80.1

(57) ABSTRACT

A dowel for a lightweight building material contains on its outside a self-tapping thread and at its tip a cutting edge with which it can be screwed into a plasterboard. At the end opposite to the tip the inner opening of the sleeve is constructed with a hexagonal cross-section, to which is connected an area of the inner opening in which the screw can cut its own thread. The area of the bit intended for engagement in the chuck of a driving tool is used for screwing in the dowel, because this hexagonal area projects somewhat from the chuck, so that it can engage in the hexagonal recess of the dowel sleeve.

The invention is directed at a dowel for lightweight building materials. Such a dowel is already known (EP 618376). Said dowel has a dowel sleeve provided at its front end with a self-cutting tip. On its outside the dowel sleeve has a self-cutting thread. The inner opening extending through the entire dowel is shaped like a circular cylinder with inwardly projecting triangular ribs. Thus, a cruciform cross-section is formed. Into the dowel can be screwed a screw, shaping its thread in the ribs. For screwing the dowel sleeve into the lightweight building material use can be made of a Phillips screwdriver, which can also serve for screwing the screw into the fixed dowel sleeve. This has the advantage that there is no need to change the tool.

The screws used with such dowels are mainly countersunk screws.

The standard cross-recesses and the associated tools have a transverse dimension decreasing in the direction of the free end of the tool or the bottom of the driving recess. Therefore the largest transverse dimension of the tool is sufficiently large to enable the same tool used for screwing in the screw to be used for screwing in the dowel.

In the case of screwdriving recesses and tools, where the transverse dimension only slightly decreases, e.g. hexagonal recesses, the tool must have different dimensions for a screw head. Its maximum transverse dimension is not sufficient for producing a rotary connection between the inner opening of the dowel sleeve and the tool.

A screw-in dowel for soft building materials is already known (DE-U1-29812947). The latter has an inner opening with a circular cross-section for receiving a screwed shank and the front part of the inner opening has a hexagonal cross-section and is used for inserting a lathe tool.

The problem of the invention is to provide a dowel, especially for lightweight building materials, in which it is possible, even in the case of other shapes of the screwdriving recess to make do with a single tool for the dowel and for the screw.

For solving this problem the invention proposes a dowel having the features of claim 1. Further developments. of the invention form the subject matter of the dependent claims, whose wording, like that of the abstract, is by reference made into part of the content of the present description.

The tools for screwing in screws are normally known as bits. All bits have a size-standardized hexagonal attachment with which they can be used in an electric screwdriver. From said hexagonal attachment extends in the forwards direction the actual driving tool, whose transverse dimension is normally smaller than that of the hexagonal attachment. As a result of the hexagonal shape of the recess of the front region of the dowel sleeve the hexagonal attachment projecting somewhat out of the tool chuck can now be used for screwing in the dowel sleeve. Use can be made of the tool which is also employed for screwing in the screw. Thus, with the minimum of effort and expenditure it is also possible to make do with drive shapes differing from a cross-recess with a single tool and without any need for replacement. A further advantage results from the fact that the driving tool can enter more deeply the dowel sleeve, so that during the screwing in of the dowel better guidance thereof is possible.

The axial length of the hexagonal shape of the inner opening need only be small, because said shape is mainly used for torque transmission. Thus, it can e.g. be sufficient if the axial length is at least roughly half the length of the side of the hexagon.

The remaining area of the inner opening can be in the form of a cylindrical opening in which a thread is already cut. However, it can in particular be a circular cylindrical inner opening with inwardly projecting ribs, which still have no thread, so that on screwing in the screw the latter shapes its own thread. The dowel sleeve material can e.g. be die cast zinc or plastic. It is particularly appropriate to distribute the ribs uniformly over the circumference, e.g. four ribs as in the prior art.

The ribs can be dimensioned in such a way that the tool projection intended for the screw can engage with limited clearance between the tips of the ribs.

It can in particular be provided that the dowel has a drilling or cutting tip with which the hole is formed in the lightweight building material.

The thread on the outside of the sleeve can advantageously be self-tapping.

Further features, details and advantages of the invention can be gathered from the following description of a preferred embodiment and the attached drawings, wherein show:

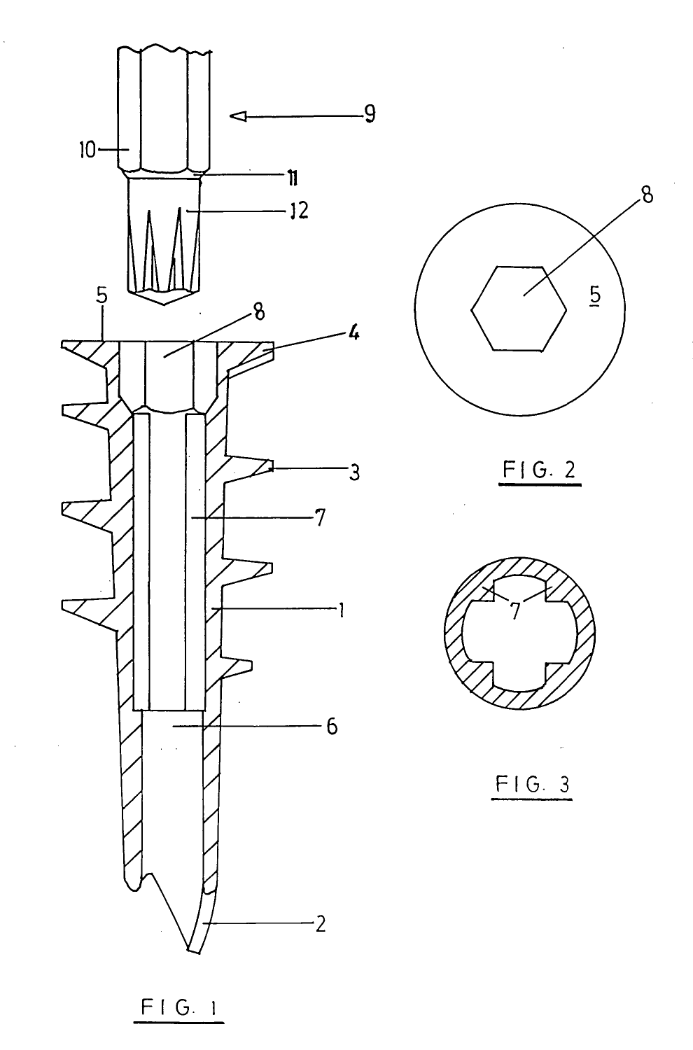

FIG. 1 A longitudinal section through a dowel sleeve according to the invention with an intimated tool.

FIG. 2 A view of the dowel from above in FIG. 1.

FIG. 3 A cross-section through the dowel roughly along line III-III.

FIG. 1 shows in longitudinal section a dowel sleeve 1, which is e.g. of die cast zinc. At its inner end, namely the lower end in FIG. 1, it contains a cutting tip 2 forming a sharp edge. The outside of the dowel sleeve is provided with a thread in the form of a self-tapping thread. The height of the thread courses increases over the dowel sleeve length. At its end associated with the front of the wall the dowel sleeve is provided with a flange-like head 4, which is bounded by a planar front face 5.

The dowel sleeve 1 contains an inner opening 6 which is circular in the area associated with the dowel tip 2, whereas in the remaining area it has four axially inwardly projecting ribs 7. In its end facing the dowel head 4 the inner opening 6 is provided with a hexagonal cross-section 8.

As can be gathered from FIG. 3, four ribs 7 are uniformly circumferentially distributed, so that the cross-section in this area is roughly cruciform.

It can be gathered from FIG. 2 that starting from the head side of the dowel there is initially an inner opening with a hexagonal cross-section.

Above the dowel in FIG. 1 a tool 9 is shown in broken away form, such as can e.g. be used for a screw. The tool contains a hexagonal attachment 10 constructed for insertion in a chuck of a driving tool. The size of the hexagonal attachment is fixed, because different tools can be inserted in a chuck. From the end face 11 of the hexagonal attachment 10 extends a tool attachment 12, which is roughly shaped like a frustum with outwardly projecting rib systems. The outside of the rib systems is located within a circle. This front tool attachment 12 can be inserted in the inner opening 6, the ribs 7 being dimensioned in such a way that the attachment has sufficient space between the ribs 7. If the tool is inserted into the dowel sleeve 1 to a sufficient extent the hexagonal attachment 10 enters with its front region the hexagonal inner opening 8 of the dowel. The dowel can then be screwed with the aid of a screwdriver into a wall, e.g. a plasterboard. As the front tool attachment 12 is at a limited distance from the ribs 7, it can be used for guiding the dowel sleeve during the commencement of screwing in.

Following the complete screwing in of the dowel sleeve the tool is extracted therefrom. The attachment 12 is then inserted in the drive structure of a screw, which is then introduced into the dowel sleeve and turned. This then cuts its own thread in the ribs 7. The dowel and the screw can be screwed in without any tool change.

1. Dowel, particularly for lightweight building materials, having
1.1 a dowel sleeve (1),
1.2 a thread (3) on the outside of the dowel sleeve (1) and
1.3 an inner opening (6),
1.3.1 accessible from the front (5) of the dowel sleeve (1) and
1.3.2 constructed for receiving a screw, wherein
1.4 the front part (8) of the inner opening (6) is in the form of a hexagonal recess.

2. Dowel according to claim 1, wherein the axial length of the hexagonal recess (8) is at least approximately half the side length of the hexagon.

3. Dowel according to claim 1 or 2, wherein the inner opening (6) of the dowel sleeve (1) has inwardly projecting ribs (7) passing in the axial direction of the dowel sleeve (1).

4. Dowel according to one of the preceding claims, wherein the ribs (7) are uniformly circumferentially distributed.

5. Dowel according to one of the preceding claims, having a drilling tip (2).

6. Dowel according to one of the preceding claims, wherein the thread (3) is self-tapping.

7. Use of a screwdriver bit for screwing in a dowel according to one of the preceding claims, the hexagon used for driving the bit engaging in the front, hexagonal part (8) of the inner opening (6).
